(19) United States
(12) Patent Application Publication
(10) Pub. No.: US 2010/0199667 A1
(43) Pub. Date: Aug. 12, 2010

(54) POWER GENERATION METHODS AND SYSTEMS

(76) Inventor: Carl T. Ullman, Ridgefield, CT (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 12/539,368

(22) Filed: Aug. 11, 2009

Related U.S. Application Data
(60) Provisional application No. 61/087,812, filed on Aug. 11, 2008.

(51) Int. Cl. F03G 4/00; F01K 7/16; G21D 5/08; F03G 6/00; F01K 25/00; F01K 13/00

(52) U.S. Cl. 60/641.2; 60/670; 60/644.1; 60/641.8; 60/671; 60/645

(57) ABSTRACT

A power generation system includes a mixing unit for receiving and combining heated fluid from a heated fluid source and working fluid to form a vapor. The system also includes a condensation unit positioned at a location having a higher elevation than the heated fluid source. The condensation unit receives the vapor from the mixing unit through a first conduit and condenses the vapor into a liquid. The system further includes a turbine positioned at a location having a lower elevation than the condensation unit. The turbine receives the liquid condensed in the condensation unit through a second conduit. The turbine is driven by the liquid to generate electric power. The system also includes a heat exchanger for transferring heat from the liquid driving the turbine to the working fluid provided to the mixing unit.

### CROSS REFERENCE TO RELATED APPLICATION

This application claims priority from U.S. Provisional Patent Application Ser. No. 61/087,812, filed on Aug. 11, 2008, entitled Active Hydroelectric Power System With CO₂ Recycling, which is incorporated by reference herein.

### BACKGROUND

The present application relates to methods and systems for generating electrical power and, more particularly, to hydroelectric power.

Thermal cycle engines operate on the basis of fractional efficiency. They are governed and limited by Carnot thermodynamics (T_{H}−T_{C}/T_{H}, where T_{H} and T_{C} are the temperatures of an available heat source and the ambient thermal environment, respectively. Such cyclic engines exhaust a quantifiable amount of waste heat, which is both an efficiency loss to the system as well as a source of thermal pollution to the exogenous environment. This waste heat is a double contributor to Global Warming in that it is literally warm by definition and additionally likely resulted from a production process that burned fossil fuels to create the heat, which releases polluting greenhouse gases into the air.

This is a significant issue in the production of electrical energy. In an attempt to improve upon their inherent inefficiency, thermal production facilities often superheat working fluids to squeeze a few more percentage points out of a generally inefficient process. On average though, these processes still discard about ⅔ of the heat energy, creating thermal pollution that kills fish when dissipated into bodies of water and contributes massively to Global Warming. Combined Heat and Power (CHP) plants can improve upon these numbers but typically only in locations where the waste heat energy can be used locally as in city centers or industrial plants.

Hydropower is a highly efficient form of energy conversion often converting about 90% of the energy presented to electricity. Hydroelectric power production is generally simple in that it only requires that water be simultaneously present in a situation where there is some natural height or “head”. The water may be dropped from the height to a power plant below where it spins the turbine converting its potential energy into kinetic energy in the process. The turbine is connected by a shaft to a generator that spins a magnetic coil creating electricity via induction according to well-understood prior art.

### BRIEF SUMMARY OF EMBODIMENTS OF THE INVENTION

A power generation system in accordance with one or more embodiments includes a mixing unit for receiving and combining heated fluid from a heated fluid source and working fluid to form a vapor. The system also includes a condensation unit positioned at a location having a higher elevation than the heated fluid source. The condensation unit receives the vapor from the mixing unit through a first conduit and condenses the vapor into a liquid. The system further includes a turbine positioned at a location having a lower elevation than the condensation unit. The turbine receives the liquid condensed in the condensation unit through a second conduit. The turbine is driven by the liquid to generate electric power. The system also includes a heat exchanger for transferring heat from the liquid driving the turbine to the working fluid provided to the mixing unit.

In accordance with one or more embodiments of the invention, a method is provided of generating electric power. The method includes the steps of: (a) combining heated fluid from a heated fluid source and working fluid to form a vapor; (b) directing the vapor to a condensation unit positioned at a location having a higher elevation than the heated fluid source; (c) condensing the vapor into a liquid at the condensation unit; (d) dropping the liquid to a turbine positioned at a location having a lower elevation than the condensation unit to drive the turbine to generate electric power; (e) transferring heat from the liquid driving the turbine to working fluid to be combined with heated fluid in step (a); and (f) repeating steps (a) through (e).

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a schematic illustration of a power generation system in accordance with one or more embodiments of the invention.

FIG. 2 is a schematic illustration of an alternate power generation system including a suspended balloon structure in accordance with one or more embodiments of the invention.

FIG. 3 is a schematic illustration of an alternate power generation system with a fractional distillation unit in accordance with one or more embodiments of the invention.

Like reference numbers denote like parts in the drawings.

### DETAILED DESCRIPTION

Various embodiments of the present invention are directed to power generation systems using vapor from a heated fluid source as a vector to convey water or other working fluids to an elevated location, from which the water can be dropped to a hydroelectric turbine to generate electricity.

In many industrial processes and nuclear and fossil fuel power generation systems, warm moist air or steam is exhausted as thermal pollution out of the top of a cooling tower or chimney. In accordance with various embodiments of the invention, the steam is instead used to generate electricity using power generation systems and methods described herein. Rather than rejecting it into the atmosphere, the steam can be condensed to distilled water at the top of the cooling tower or chimney, and the distilled water can be dropped to a hydroelectric turbine at the bottom of the tower or chimney. The hydroelectric turbine efficiently converts the potential energy of the falling water to kinetic energy and subsequently electricity. Moving the water to a higher elevation thus permits energy to be recaptured through hydroelectric power generation. The distilled water can subsequently be run through a heat exchanger to transfer heat to an additional quantity of water that can be mixed with additional waste steam to increase the quantity of water raised to the top of the tower. The distilled water can be collected and used for a variety of purposes outside of the facility.

The waste heat consumed in this process is not subject to the fractional inefficiency dictated by Carnot. This is because in this case the heat is not the transportee from a hot sink to the cool sink able to release energy only based on the difference between the two. In this case, the heated fluid is used as a transporter, conveying quantities of water or other working fluids to a position of higher potential energy, from which it can convert potential energy into kinetic energy and subsequently to electrical energy by a hydroelectric production process.

In this case, the heat applied to the system is engaged (along with its pressure counterpart) in the task of raising quantities of water or other working fluids to a higher level of potential energy through a phase change. In the phase change process, there is no need for some of the heat to be “wasted” since substantially all of it may be consumed by the working fluid in the evaporative process. The electricity produced in this case can be considered as being governed by Newtonian gravity rather than Carnot thermodynamics. Using heat exchange equipment, the loss of heat in the phase change transfer process can, in some embodiments, be limited to no more than 25%. This recycling of heat permits the next quantity of water or working fluid to or readily change to the vapor phase and be moved to the elevated condensation unit.

In cases where the waste steam is superheated, the additional energy can advantageously be marshaled to raise a quantity of ambient temperature water or other working fluid to the elevated heights. This superheated, high pressure steam can contribute to a non-mechanical vapor compression cycle that will facilitate the raising of ever greater amounts of working fluid to the top of the stack. To promote vaporization at input temperatures less than the normal boiling point, a vapor compression device can be provided as part of the evaporation system. In addition, a vacuum pump and pressure relief valve can be provided along with appropriate controls to control thermodynamic conditions in the condensation chamber.

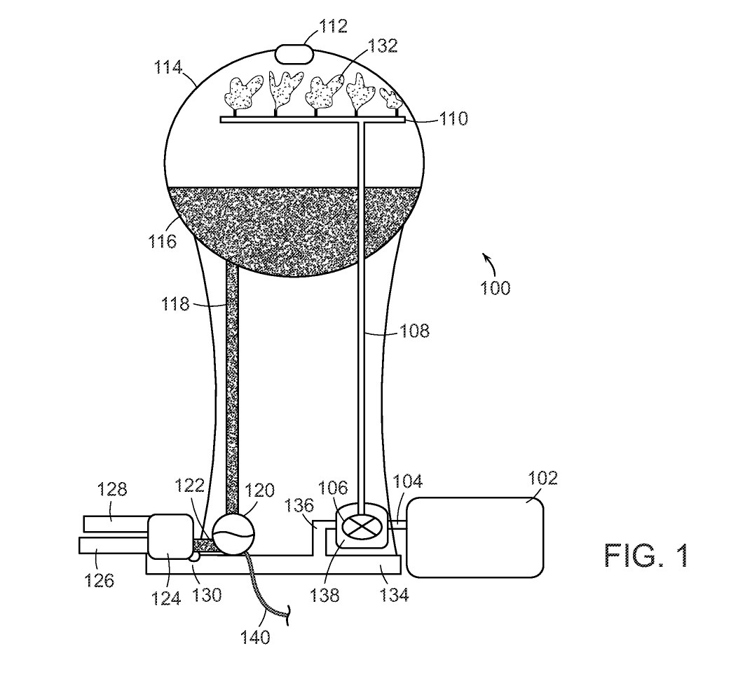

FIG. 1 illustrates an exemplary power generation system 100 in accordance with one or more embodiments of the invention. The power generation system includes a heated fluid source 102, which can be any source of heated liquids and gases including, e.g., a geothermal energy site, waste heat from an industrial facility or a nuclear or fossil fuel power plant, or spent nuclear fuel. The heated fluid can comprise a heated liquid or a heated vapor (such as steam if the fluid is water). By way of non-limiting example, in some embodiments, the heated fluid can have a temperature of about 315° C. under a pressure of about 600 psi.

The system 100 includes a mixing unit 106 coupled to the heated fluid source 102 by a conduit 104. The mixing unit 106 includes a mixing valve that combines the heated fluid from the heated fluid source 102 and a working fluid to form a vapor. As described in further detail below, the working fluid comprises a liquid received in the system 100 from conduit 128.

The heated fluid from the source 102 has a sufficiently high temperature to form a vapor with the working fluid. Vapor from the mixing unit 106 flows through a conduit 108 to a condensation unit 114, which is positioned at a location having a higher elevation than the heated fluid source 102. The condensation unit 114 condenses the vapor into a distilled liquid 116.

The system 100 further includes a hydroelectric turbine 120 at a location having a lower elevation than the condensation unit 114. Distilled liquid 116 from the condensation unit 114 is dropped through a conduit 118 to the turbine 120. The distilled liquid drives the turbine 120 and converts the potential energy of the falling distilled liquid into electricity, which can be exported through an electrical cable 140.

The system also includes a heat exchanger 124 for recovering heat from the distilled liquid driving the turbine 120 and transferring it to the working fluid provided to the mixing unit 106. The heat exchanger 124 receives distilled liquid from the turbine 120 through a conduit 122. The heat exchanger 124 receives the working fluid from a conduit 128, and expels the distilled liquid out of the system through a conduit 126. The distilled liquid can be collected and used for various purposes including, e.g., irrigation, or drinking water, or it can be disposed.

The working fluid heated by the heat exchanger 124 is deposited via a conduit 130 into a sump 134, from which it is drawn through a conduit 136 to the mixing unit 106. The mixing unit 106 includes one or more sensors to determine the pressure and temperature conditions of the incoming working fluid and heated fluid from the heated fluid source 102 in order to determine a suitable mixture to form a vapor that generally maximizes flow of the working fluid to the condensation chamber. In some embodiments, the mixing unit 106 includes a steam to water mixing valve.

In addition, the system can include a vapor compression unit 138 for compressing vapor formed in the mixing unit 106 to promote vaporization at input temperatures less than the normal boiling point. The vapor compression unit 138 includes a vapor compression chamber and a vapor compression system.

In some embodiments, the condensation unit 114 comprises a domed enclosure, which includes a misting bar 110 for receiving vapor from the conduit 108 and dispersing it as misted vapor 132 within the domed enclosure to promote condensation. The condensation unit 114 can also be equipped with a vacuum pump apparatus and a pressure relief valve 112, which allows control of the thermodynamic conditions in the enclosure.

In some embodiments, the system 100 is implemented in a cooling tower or stack of a nuclear or fossil fuel power plant or industrial facility. Collecting and condensing rejected steam from a cooling tower or stack combined with the subsequent dropping of the water to a turbine positioned at the bottom of the tower produces additional electricity for the cost of a contained condenser and a turbine/generator complex. The extra electricity is produced generally without any additional fuel or carbon dioxide production. In addition, by reducing vapor that would normally be expelled into the environment, the system reduces thermal pollution.

In some embodiments, the system 100 is implemented at a geothermal site. Geothermal sites typically provide great heat combined with moisture. As geothermal sites are usually recessed deeply into the subsurface of the earth, they can be used to drop water from the surface into a sump or well containing a turbine near the geothermal site causing electricity to be produced at depth. The electricity produced may then be returned to the surface in an electric cable in a conduit along with the water previously dropped. The water previously dropped is heated to steam by geothermal energy and allowed to rise through the conduit. At the surface, the steam is condensed into distilled water. The distilled water may be dropped again to produce additional electricity or it may be traded out if the distilled water is to be utilized, e.g., for irrigation. Each cycle of this process loses some of the heat produced, but the heat exchanger 124 can be used to limit the heat loss (e.g., to a loss of up to 25% of the total heat needed to convert the water to steam).

In some embodiments, the heated fluid source 102 of the system 100 comprises fluid that has been heated using spent nuclear fuel. Spent nuclear fuel is nuclear fuel used in a nuclear reactor that is no longer useful in sustaining a nuclear reaction. Heat emitted from spent nuclear fuel can be transferred through a heat exchanger to the fluid in the heated fluid source 102.

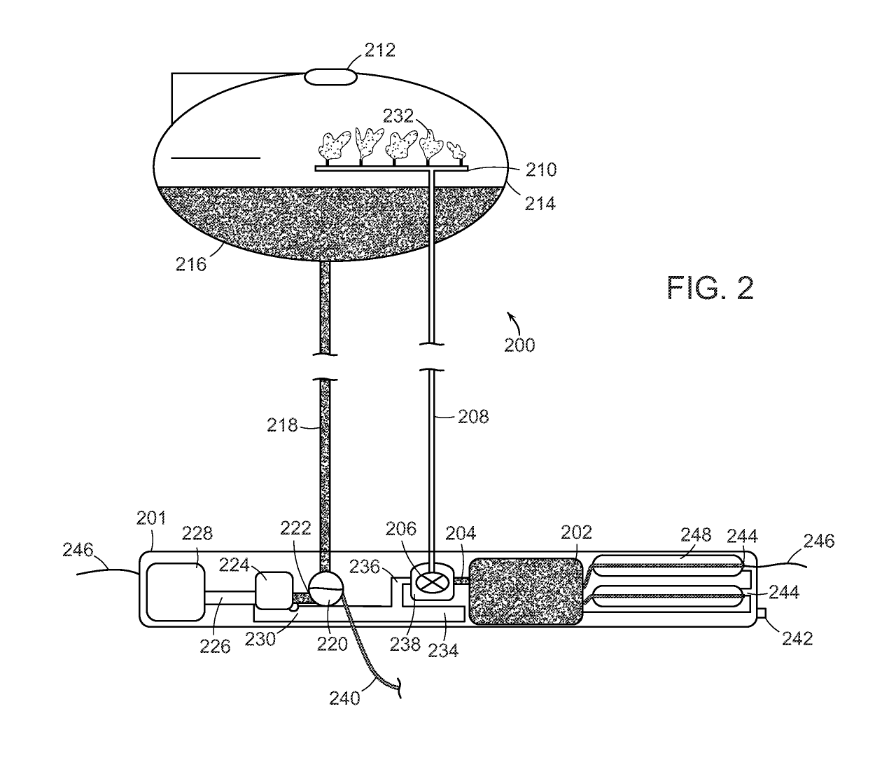

FIG. 2 illustrates an exemplary power generation system 200 in accordance with one or more embodiments of the invention. The power generation system 200 includes a base structure 201 that can float (such as a barge) or be fixedly positioned on the surface of a body of water 246 (such as a lake, pond, or ocean).

The system 200 includes a heated fluid source 202, positioned on the base structure 201. The heated fluid source 202 can contain any heated liquids or gases. In the illustrated embodiment, the heated fluid source 202 comprises water received from the body of water 246 that has been heated by one or more arrays of solar thermal cells 248. Water from the body of water 246 is received by the solar thermal cells 248 via intake valve 242 and conduit 244. The heated water in the heated fluid source 202 can be in liquid or vapor form.

The system 200 includes a mixing unit 206 coupled to the heated fluid source 202 by a conduit 204. The mixing unit 206 includes a mixing valve that combines the heated fluid from the heated fluid source 202 and a working fluid to form a vapor. In the illustrated example, the working fluid comprises water from the body of water 246.

The heated fluid from the source 202 has a sufficiently high temperature to form a vapor with the working fluid. In addition, various known evaporative technologies can be used to increase the efficiency of the evaporation process including, e.g., vacuum-assisted evaporation and condensation.

Vapor from the mixing unit 206 is flows through a conduit 208 to a condensation unit 214, which is positioned at a location having a higher elevation than the heated fluid source 202. The condensation unit 214 condenses the vapor into a distilled liquid 216.

In the FIG. 2 embodiment, the condensation unit 214 comprises a balloon having sufficient buoyancy to remain suspended in the air. The balloon maintains a steady position relative to the barge 201 by being suitably tethered to the barge. In other embodiments, the condensation unit 214 can comprise a non-floatation structure that is fixedly secured at an elevation above the barge 201.

The condensation unit 214 includes a misting bar 210 for receiving vapor from the conduit 208 and dispersing it as misted vapor 232 within the interior of the balloon 214 to promote condensation. The condensation chamber can also be equipped with a vacuum pump apparatus and a pressure relief valve 212, which allows control of the thermodynamic conditions in the enclosure.

The system 200 further includes a hydroelectric turbine 220 at a location having a lower elevation than the condensation unit 214. Distilled liquid 216 from the condensation unit 214 is dropped through a conduit 218 to the turbine 220. The distilled liquid 216 drives the turbine 220 and converts the potential energy of the falling distilled liquid into electricity, which can be exported using electrical cable 240.

The system also includes a heat exchanger 224 for recovering heat from the distilled liquid driving the turbine 220 and transferring it to the working fluid (water from the body of water 246 in this example) provided to the mixing unit 206. The heat exchanger 224 receives distilled liquid from the turbine 220 through a conduit 222. The heat exchanger 224 transfers the distilled liquid to a storage tank 228 through a conduit 226.

The working fluid heated by the heat exchanger 224 is deposited via a conduit 230 into a sump 234, from which it is drawn through a conduit 236 to the mixing unit 206. The mixing unit 206 includes one or more sensors to determine the pressure and temperature conditions of the incoming working fluid and heated fluid from the heated fluid source 202 in order to determine a suitable mixture to form a vapor that generally maximizes flow of the working fluid to the condensation chamber. In some embodiments, the mixing unit 206 includes a steam to water mixing valve.

In addition, the system 200 can include a vapor compression unit 238 for compressing vapor formed in the mixing unit 206 to promote vaporization at input temperatures less than the normal boiling point. The vapor compression unit 238 includes a vapor compression chamber and a vapor compression system.

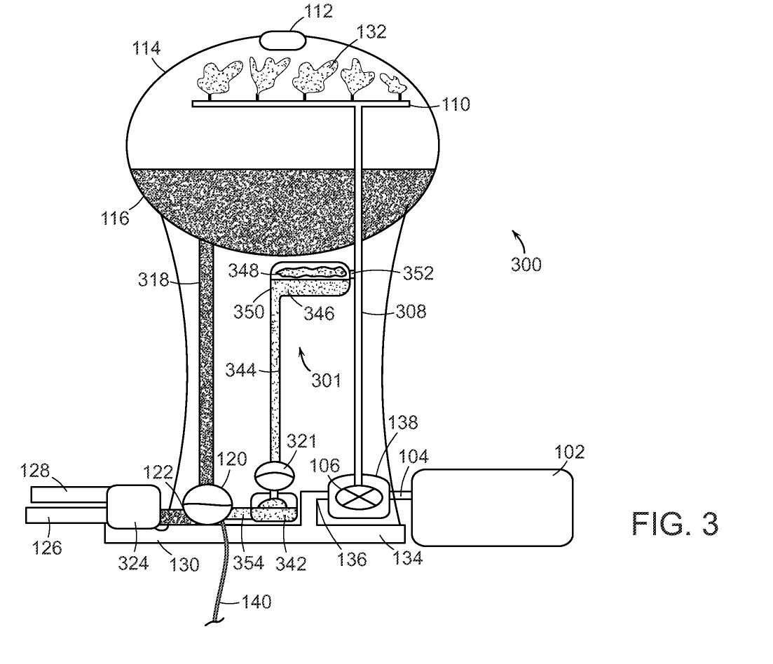

FIG. 3 illustrates an exemplary power generation system 300 in accordance with one or more embodiments of the invention. The power generation system 300 is similar to the power generation system 100 or FIG. 1, but additionally includes a fractional distillation apparatus 301 to create distilled alcohol products that can be used as alternate fuels, e.g., to replace petroleum products. In this embodiment, the working fluid comprises a substance that can be subjected to a fractional distillation process to separate it into usable component parts. For example, the working fluid can comprise an alcohol product such as, whey wine or other fermented prospective bio-fuel components that can be distilled.

The fractional distillation apparatus 301 comprises a condensation chamber 350 that is coupled to the conduit 308, which transfers vapor from the mixing unit 106 to the condensation unit 114. The condensation chamber 350 is coupled to the conduit 308 through a fractional distillate valve 352. The conduit 308 comprises a fractional distillation column as is known in the art of fractional distillation. The water component of the solute is lifted by the superheated steam beyond the fractional distillate valve 352 to the condensation unit 114. Fractional distillate vapor 348 of high proof alcohol is separated at the fractional distillate valve 352 and collected in the condensation chamber 350. The fractional distillate vapor 348 is condensed in the condensation chamber 350 into high proof alcohol 346 and transferred through a conduit 344 to a distilled spirits tank 342. The high proof alcohol collected in the tank 342 can be used for various purposes including as a petroleum product alternative.

The system 300 further includes a hydroelectric turbine 321 that is driven by the high proof alcohol dropped through the conduit 344 to generate additional electricity.

As with the system 100 of FIG. 1, the system 300 includes a condensation unit 114, which condenses the vapor from conduit 308 into a liquid 116 that is dropped to a turbine 120 to drive the turbine 120 to generate electricity. A heat exchanger 324 transfers heat from the distilled liquid to the incoming working fluid. Additionally, the heat exchanger 324 is configured to transfer heat from the high proof alcohol distilled in the fractional distillation apparatus to the working fluid. A conduit 354 is provided to transfer the high proof alcohol from the tank 342 to the heat exchanger 324.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A power generation system, comprising:
a mixing unit for receiving and combining heated fluid from a heated fluid source and working fluid to form a vapor;
a condensation unit positioned at a location having a higher elevation than the heated fluid source, the condensation unit receiving the vapor from the mixing unit through a first conduit and condensing the vapor into a liquid;
a turbine positioned at a location having a lower elevation than the condensation unit, the turbine receiving the liquid condensed in the condensation unit through a second conduit, and the turbine being driven by the liquid to generate electric power; and
a heat exchanger for transferring heat from the liquid driving the turbine to the working fluid provided to the mixing unit.

2. The power generation system of claim 1 further comprising a vapor compression unit for compressing the vapor from the mixing unit.

3. The power generation system of claim 1 wherein the condensation unit comprises an enclosure including a misting apparatus for promoting condensation of the vapor.

4. The power generation system of claim 3 wherein the condensation unit further comprises a vacuum pump and a pressure relief valve.

5. The power generation system of claim 1 wherein the heated fluid source comprises a reservoir of fluid carrying waste heat from a nuclear power plant, a fossil fuel power plant, or an industrial facility.

6. The power generation system of claim 1 wherein the heated fluid source comprises a reservoir of fluid heated by geothermal energy or spent nuclear fuel.

7. The power generation system of claim 1 wherein the system is installed in a cooling tower of a nuclear power plant.

8. The power generation system of claim 1 wherein the heated fluid source, the mixing unit, and the turbine are located below ground.

9. The power generation system of claim 1 wherein the condensation unit is housed in a balloon suspended a given distance above the turbine.

10. The power generation system of claim 1 wherein the heated fluid source comprises a sump containing fluid heated by a solar thermal heating apparatus.

11. The power generation system of claim 10 wherein the sump and solar thermal heating apparatus are located proximate a body of water, and wherein the condensation unit is suspended in the air above the sump using a balloon.

12. The power generation system of claim 1 wherein the working fluid and the heated fluid each comprise a mixture separable into component parts, and wherein the power generation system further comprises a fractional distillation unit coupled to the first conduit for receiving and condensing vapor containing one of the component parts, and collecting the distillate.

13. The power generation system of claim 12 further comprising a heat exchanger for transferring heat from the distillate to the working fluid provided to the mixing unit.

14. The power generation system of claim 12 wherein the working fluid and the heated fluid each comprises an alcohol based product.

15. The power generation system of claim 1 wherein the heated fluid comprises steam, and the working fluid comprises water.

16. The power generation system of claim 1 wherein the mixing unit includes a steam to water mixing valve.

17. The power generation system of claim 1 wherein pressurization of the heated fluid from the heated fluid source promotes vaporization of the working fluid in the mixing unit and conveyance of the vapor to the condensation unit.

18. A method of generating electric power, comprising:
(a) combining heated fluid from a heated fluid source and working fluid to form a vapor;
(b) directing the vapor to a condensation unit positioned at a location having a higher elevation than the heated fluid source;
(c) condensing the vapor into a liquid at the condensation unit;
(d) dropping the liquid to a turbine positioned at a location having a lower elevation than the condensation unit to drive the turbine to generate electric power;
(e) transferring heat from the liquid driving the turbine to working fluid to be combined with heated fluid in step (a); and
(f) repeating steps (a) through (e).

19. The method of claim 18 further comprising compressing the vapor.

20. The method of claim 18 further comprising heating the fluid in the heated fluid source with waste heat from a nuclear power plant, a fossil fuel power plant, or an industrial facility.

21. The method of claim 18 further comprising heating the fluid in the heated fluid source with heat from a geothermal energy site, spent nuclear fuel, or a solar thermal heating apparatus.

22. The method of claim 18 further comprising raising a balloon containing the condensation chamber to the higher elevation.

23. The method of claim 18 wherein the working fluid and the heated fluid each comprise a mixture separable into component parts, and wherein the method further comprises a using a fractional distillation process for condensing vapor containing one of the component parts, and collecting the distillate.

24. The method of claim 23 further comprising transferring heat from the distillate to the working fluid.

25. The method of claim 18 wherein pressurization of the heated fluid from the heated fluid source promotes vaporization of the working fluid and conveyance of the vapor to the condensation unit.
